(19) United States
(12) Patent Application Publication
(10) Pub. No.: US 2010/0172266 A1
(43) Pub. Date: Jul. 8, 2010

(54) DYNAMIC NETWORK CONFIGURATION FOR A NETWORK DEVICE

(75) Inventors: Sandro Piccinini, Rome (IT); Luigi Pichetti, Rome (IT); Marco Secchi, Rome (IT); Francesco Termine, Palermo (IT)

Correspondence Address: IBM AUSTIN IPLAW (DG), C/O DELIZIO GILLIAM, PLLC, 15201 MASON ROAD, SUITE 1000-312, CYPRESS, TX, 77433, US

(73) Assignee: International Business Machines Corporation, Armonk, NY (US)

(21) Appl. No.: 12/348,678

(22) Filed: Jan. 5, 2009

(51) Int. Cl. H04L 12/28

(52) U.S. Cl. 370/254

(57) ABSTRACT

A network services profile can be associated with a unique device identifier, such as a MAC address, rather than an IP address. When a network device is connected to a network, a network management server can recognize the unique device identifier and retrieve the network services profile. The network management server can automatically enables network services indicated in the network services profile.

### BACKGROUND

Embodiments of the inventive subject matter generally relate to the field of networks, and, more particularly, to dynamic network configuration for a network device.

A network administrator manually configures network services for network devices (e.g., computers, routers, servers, etc.) based on internet protocol (IP) addresses of the network devices. Network devices that maintain persistent network connections can be assigned static IP addresses. However, dynamic IP addresses may be assigned to network devices that do not maintain persistent network connections. For example, an employee may take a company laptop home every evening. Each morning, the employee connects the laptop to the company's network when he arrives at work. Each time the laptop is connected to the network, a different IP address is assigned to the laptop. Because network service configurations are associated with IP addresses, network services for the laptop are manually reconfigured each time a new IP address is assigned to the laptop.

### SUMMARY

Embodiments include a method directed to a network management server detecting connection of a first network device to a network. A first unique device identifier of the first network device is determined. The first unique device identifier is associated with a first network services profile. The first network services profile indicates network services to configure for the first network device. The first network services profile is retrieved from a profile database. The network services indicated in the first network services profile are configured. A first network address is assigned to the first network device.

### BRIEF DESCRIPTION OF THE DRAWINGS

The present embodiments may be better understood, and numerous objects, features, and advantages made apparent to those skilled in the art by referencing the accompanying drawings.

FIG. 1 is an example conceptual diagram of automatically configuring network services based on a unique device identifier.

FIG. 2 is an example conceptual diagram of automatically configuring network services based on a network service profile associated with a unique device identifier.

FIG. 3 is a flowchart of example operations for automatically configuring network services based on a unique device identifier.

FIG. 4 is a flowchart of example operations for automatically releasing network services when a network device is disconnected.

FIG. 5 depicts an example computer system.

### DESCRIPTION OF EMBODIMENT(S)

The description that follows includes exemplary systems, methods, techniques, instruction sequences and computer program products that embody techniques of the present inventive subject matter. However, it is understood that the described embodiments may be practiced without these specific details. For instance, although examples refer to Dynamic Host Configuration Protocol (DHCP) servers, embodiments can be implemented in other types of network management servers. In other instances, well-known instruction instances, protocols, structures, and techniques have not been shown in detail in order not to obfuscate the description.

Manually reconfiguring network services for a network device when an IP address of the network device changes can become inconvenient and cumbersome. For example, an information technology (IT) technician may be tasked to troubleshoot network problems in multiple geographic locations. The IT technician may connect a laptop to the network at each geographic location to run diagnostic tests. A new IP address is assigned each time the laptop is connected to the network. Therefore, the IT technician has to manually reconfigure network services each time she changes geographic locations. A network services profile can be associated with a unique device identifier, such as a Media Access Control (MAC) address, rather than an IP address. When a network device is connected to a network, a network management server can recognize the unique device identifier and retrieve the network services profile. The network management server can automatically enable network services indicated in the network services profile.

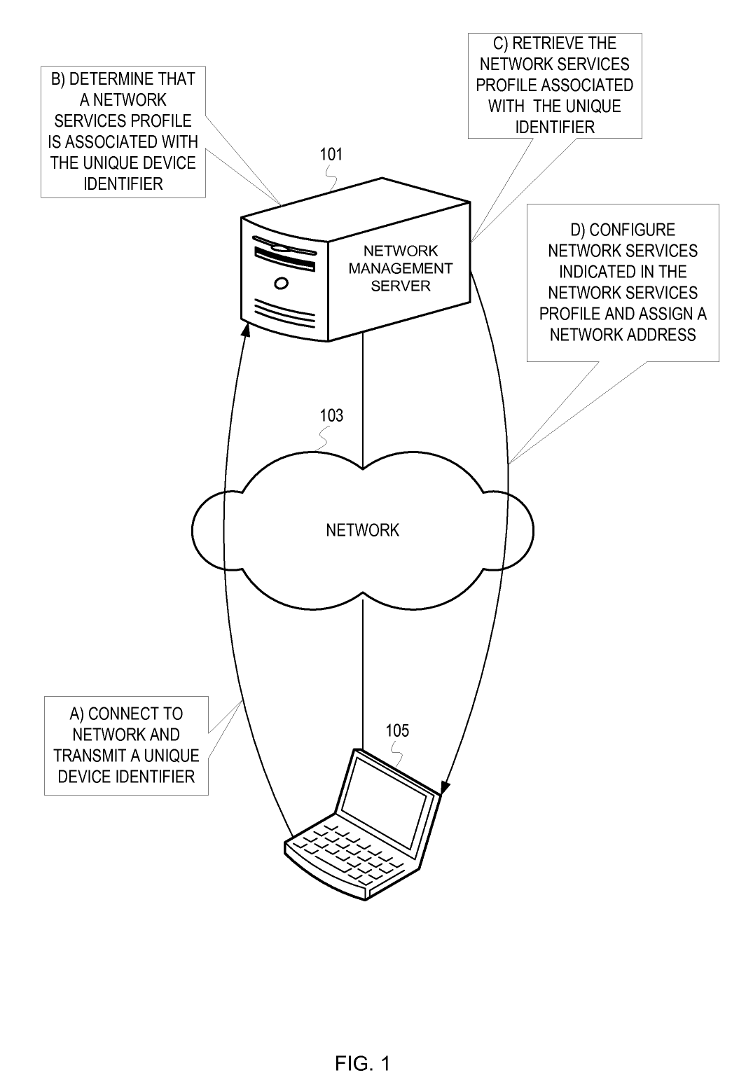

FIG. 1 is an example conceptual diagram of automatically configuring network services based on a unique device identifier. A network management server 101 is connected to a network 103. In this example, the network management server 101 is a DHCP server. At stage A, a network device, laptop 105, connects to the network 103 and transmits a unique device identifier. Other examples of network devices include a personal digital assistant, a mobile phone, a printer, etc. Examples of a unique device identifier include a MAC address, a serial number, a device name, etc.

At stage B, the network management server 101 determines that a network services profile is associated with the unique device identifier. Determining the unique device identifier can comprise searching a profile database for the unique device identifier. The database may be hosted on the network management server 101, a second server, a network drive, etc.

At stage C, the network management server 101 retrieves the network services profile associated with the unique device identifier from the profile database. The network services profile indicates network services that should be configured for laptop 105. Examples of network services include port forwarding, port address translation (PAT), ports to be opened on a firewall, access to a remote server, access to a virtual private network (VPN), etc.

At stage D, the network management server 101 configures the network services indicated in the network services profile and assigns a network address (e.g. an IP address, etc.) to the laptop 105. Configuring a network service can involve setting values on a server to allow the service for a laptop, enabling services on a router, etc.

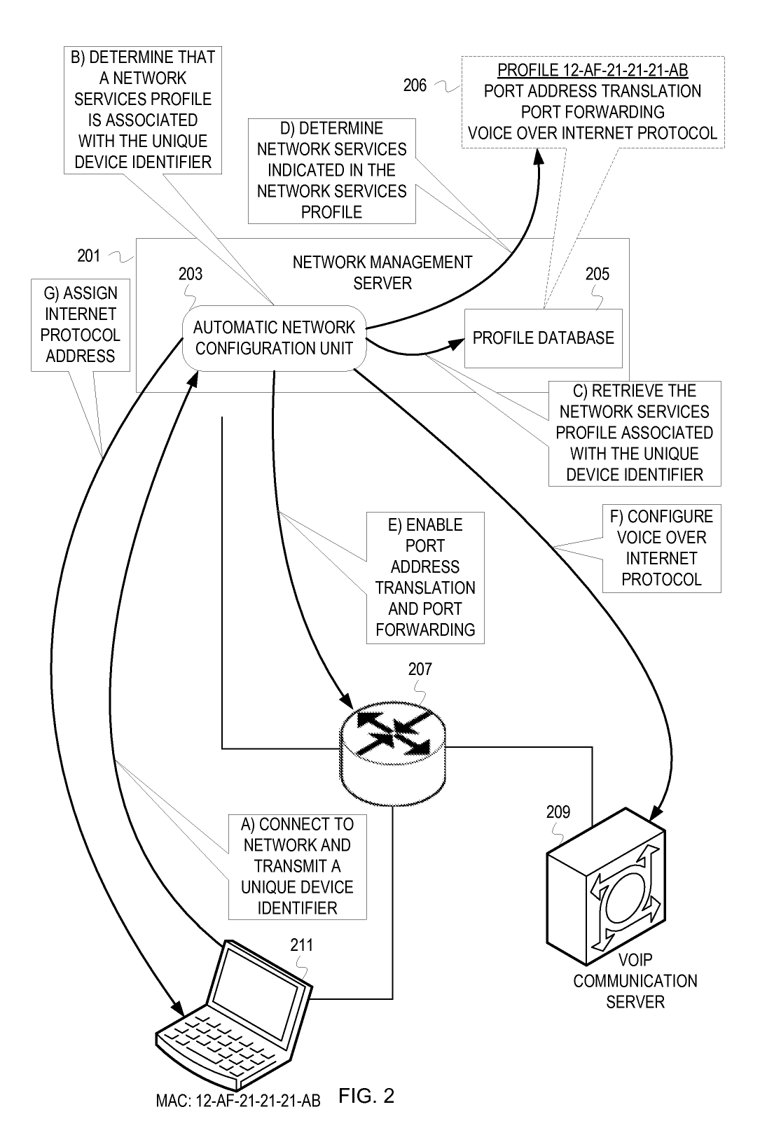

FIG. 2 is an example conceptual diagram of automatically configuring network services based on a network service profile associated with a unique device identifier. A network management server 201 comprises an automatic network configuration unit 203 and a profile database 205. The network management server 201 is communicatively coupled to a router 207. The router 207 is communicatively coupled to a Voice over Internet Protocol (VoIP) communication server 209.

At stage A, a laptop 211 connects to the router 207 and transmits a unique device identifier. In this example, laptop 211 transmits its MAC address, 12-AF-21-21-21-AB.

At stage B, the automatic network configuration unit 203 receives the unique device identifier and determines that a network profile is associated with the unique device identifier.

At stage C, the automatic network configuration unit 203 retrieves the network services profile 206 associated with the unique device identifier from the profile database 205. Although the profile database 205 is depicted on the network management server 201, the profile database 205 may be on a second server, a network drive, etc.

At stage D, the automatic network configuration unit 203 determines network services indicated in the network services profile 206. In this example, network services indicated in the network services profile comprise port address translation, port forwarding, and VoIP.

At stage E, the automatic network configuration unit 203 configures the router 207 to enable port address translation and port forwarding.

At stage F, the automatic network configuration unit 203 configures the VoIP communication server 209 to enable VoIP for laptop 211.

At stage G, the automatic network configuration unit 203 assigns an IP address to laptop 211.

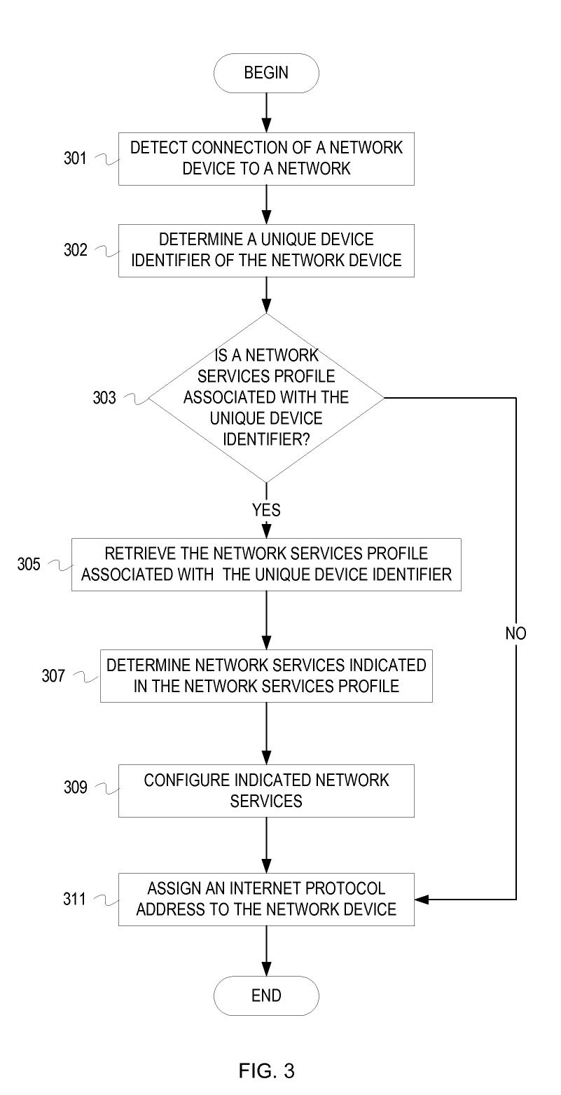

FIG. 3 is a flowchart of example operations for automatically configuring network services based on a unique device identifier. Flow begins at block 301, where connection of a network device to a network is detected. For example, a DHCP server detects connection of a network device when it receives a discover packet from a network device.

At block 302, a unique device identifier of the network device is determined. For example, the unique device identifier is contained in a discover packet. As another example, a network management server sends a query to the network device requesting the unique device identifier.

At block 303, it is determined if a network services profile is associated with the unique device identifier. For example, a profile database is searched for the unique device identifier. If a network services profile is associated with the unique device identifier, flow continues at block 305. If a network services profile is not associated with the unique device identifier, flow continues at block 311.

At block 305, the network services profile associated with the unique device identifier is retrieved. For example, the network services profile is retrieved from a profile database stored on a network drive.

At block 307, network services indicated in the network services profile are determined. For example, the indicated network services include port address forwarding, port numbers to be opened on a firewall and access to a VPN.

At block 309, the indicated network services are configured.

At block 311, an IP address is assigned to the network device.

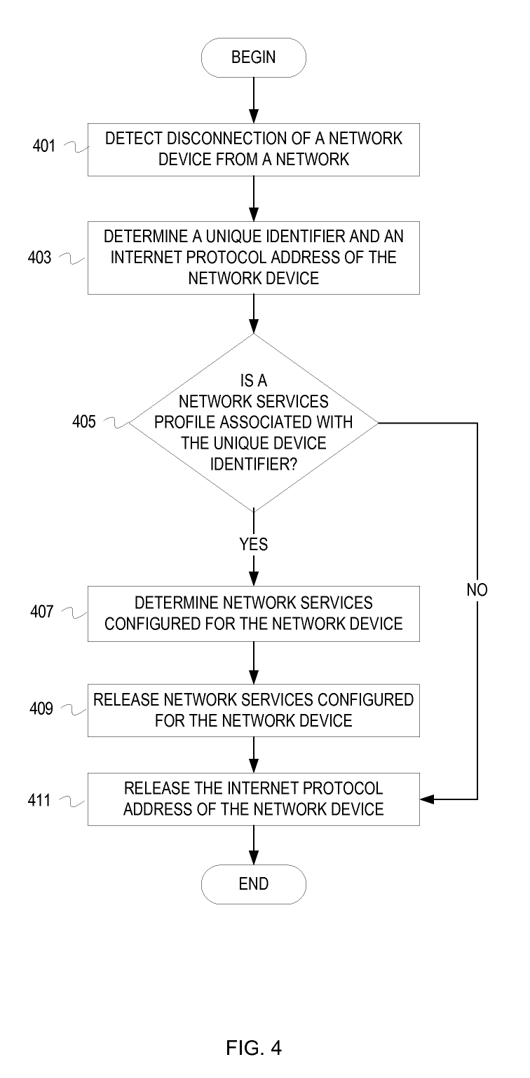

In addition to automatically configuring network services when a network device is connected, configured network services can be automatically released when the network device is disconnected. FIG. 4 is a flowchart of example operations for automatically releasing network services when a network device is disconnected. Flow begins at block 401, where disconnection of a network device from a network is detected. For example, a DHCP server receives a release packet.

At block 403, a unique identifier and the IP address of the network device are determined. For example, the unique device identifier and the IP address are contained in the release packet. As another example, the IP address is contained in the release packet and a network management server accesses a table containing unique device identifiers referenced by assigned IP address.

At block 405, it is determined if a network services profile is associated with the unique device identifier. For example, a network management server searches a profile database for the unique device identifier. If a network services profile is associated with the unique device identifier, flow continues at block 407. If a network services profile is not associated with the unique device identifier, flow continues at block 411.

At block 407, network services configured for the network device are determined. Determining configured network services comprises retrieving the network services profile from a profile database, accessing a structure indicating network services configured for the network device based on a unique device identifier or IP address.

At block 409, network services configured for the network device are released. For example, VPN access is terminated for the network device. As another example, port forwarding is disabled for the network device.

At block 411, the IP address of the network device is released.

Embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments of the inventive subject matter may take the form of a computer program product embodied in any tangible medium of expression having computer usable program code embodied in the medium. The described embodiments may be provided as a computer program product, or software, that may include a machine-readable medium having stored thereon instructions, which may be used to program a computer system (or other electronic device(s)) to perform a process according to embodiments, whether presently described or not, since every conceivable variation is not enumerated herein. A machine-readable medium includes any mechanism for storing or transmitting information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read only memory (ROM); random access memory (RAM); erasable programmable memory (e.g., EPROM and EEPROM); flash memory; or other types of medium suitable for storing electronic instructions. In addition, embodiments may be embodied in an electrical, optical, acoustical or other form of propagated signal (e.g., carrier waves, infrared signals, digital signals, etc.), or wireline, wireless, or other communications medium.

Computer program code for carrying out operations of the embodiments may be written in any combination of one or more programming languages, including an object oriented programming language such as Java, Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN), a personal area network (PAN), or a wide area network (WAN), or the connection may be made to an external computer (for example, through the Internet using an Internet Service Provider).

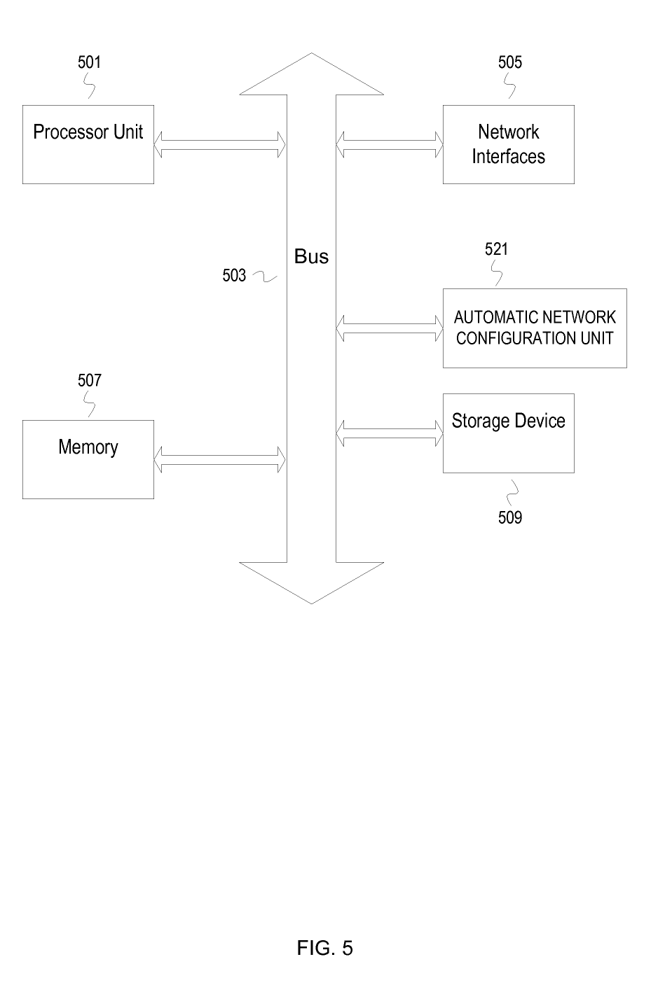

FIG. 5 depicts an example computer system. A computer system includes a processor unit 501 (possibly including multiple processors, multiple cores, multiple nodes, and/or implementing multi-threading, etc.). The computer system includes memory 507. The memory 507 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computer system also includes a bus 503 (e.g., PCI, ISA, PCI-Express, HyperTransport®, InfiniBand®, NuBus, etc.), a network interface 505 (e.g., an ATM interface, an Ethernet interface, a Frame Relay interface, SONET interface, wireless interface, etc.), and a storage device(s) 509 (e.g., optical storage, magnetic storage, etc.). The computer system also includes an automatic network configuration unit 521 that detects connection of a network device to a network, determines if a network services profile is associated with a unique device identifier of the network device and configures network services indicated in the network services profile. Any one of these functionalities may be partially (or entirely) implemented in hardware and/or on the processing unit 501. For example, the functionality may be implemented with an application specific integrated circuit, in logic implemented in the processing unit 501, in a co-processor on a peripheral device or card, etc. Further, realizations may include fewer or additional components not illustrated in FIG. 5 (e.g., video cards, audio cards, additional network interfaces, peripheral devices, etc.). The processor unit 501, the storage device(s) 509, and the network interface 505 are coupled to the bus 503. Although illustrated as being coupled to the bus 503, the memory 507 may be coupled to the processor unit 501.

While the embodiments are described with reference to various implementations and exploitations, it will be understood that these embodiments are illustrative and that the scope of the inventive subject matter is not limited to them. In general, techniques for dynamic network configuration for a network device as described herein may be implemented with facilities consistent with any hardware system or hardware systems. Many variations, modifications, additions, and improvements are possible.

Plural instances may be provided for components, operations, or structures described herein as a single instance. Finally, boundaries between various components, operations and data stores are somewhat arbitrary, and particular operations are illustrated in the context of specific illustrative configurations. Other allocations of functionality are envisioned and may fall within the scope of the inventive subject matter. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. A method comprising:
a network management server detecting connection of a first network device to a network;
determining a first unique device identifier of the first network device;
determining that the first unique device identifier is associated with a first network services profile, wherein the first network services profile indicates network services to configure for the first network device;
retrieving the first network services profile from a profile database;
configuring network services indicated in the first network services profile for the first network device; and
assigning a first network address to the first network device.

2. The method of claim 1, wherein said detecting connection of the first network device to the network comprises receiving a discover packet from the first network device.

3. The method of claim 1, wherein the first unique device identifier comprises at least one of a Media Access Control (MAC) address, a serial number, and a device name.

4. The method of claim 1, wherein said determining the first unique device identifier of the first network device comprises at least one of examining a discover packet from the first network device and requesting the first unique device identifier from the first network device.

5. The method of claim 1, wherein said determining that the first unique device identifier is associated with a first network services profile comprises searching the profile database for the first unique device identifier.

6. The method of claim 1, wherein the profile database is hosted on at least one of the network management server, a second server, and a network drive.

7. The method of claim 1 further comprising:
detecting disconnection of a second network device from the network;
determining a second unique device identifier of the second network device;
determining if the second unique device identifier is associated with a second network services profile;
determining network services configured for the second network device based, at least in part, on the second network services profile; and
releasing the network services configured for the second network device.

8. The method of claim 7, wherein said detecting disconnection of the second network device from the network comprises receiving a release packet from the second network device.

9. The method of claim 7, wherein said determining the second unique device identifier of the second network device further comprises at least one of examining a release packet from the second network device, and accessing a table containing unique device identifiers referenced by assigned network addresses.

10. One or more machine-readable media having stored therein a program product, which when executed by a set of one or more processor units causes the set of one or more processor units to perform operations that comprise:
detecting connection of a first network device to a network;
determining a first unique device identifier of the first network device;
determining that the first unique device identifier is associated with a first network services profile, wherein the first network services profile indicates network services to configure for the first network device;
retrieving the first network services profile from a profile database;
configuring network services indicated in the first network services profile; and
assigning a first network address to the first network device.

11. The machine-readable media of claim 10, wherein said operation of detecting connection of the first network device to the network comprises receiving a discover packet from the first network device.

12. The machine-readable media of claim 10, wherein said operation of detecting connection of the first network device to the network comprises receiving a discover packet from the first network device.

13. The machine-readable media of claim 10, wherein the first unique device identifier comprises at least one of a Media Access Control (MAC) address, a serial number, and a device name.

14. The machine-readable media of claim 10, wherein said operation of determining the first unique device identifier of the first network device comprises at least one of examining a discover packet from the first network device and requesting the first unique device identifier from the first network device.

15. The machine-readable media of claim 10, wherein said operation of determining that the first unique device identifier is associated with a first network services profile comprises searching the profile database for the first unique device identifier.

16. The machine-readable media of claim 10, wherein the profile database is hosted on at least one of the network management server, a second server, and a network drive.

17. The machine-readable media of claim 10, wherein the operations further comprise:
detecting disconnection of a second network device from the network;
determining a second unique device identifier of the second network device;
determining if the second unique device identifier is associated with a second network services profile;
determining network services configured for the second network device based, at least in part, on the second network services profile; and
releasing the network services configured for the second network device.

18. The machine-readable media of claim 17, wherein said operation of detecting disconnection of the second network device from the network comprises receiving a release packet from the second network device.

19. The machine-readable media of claim 17, wherein said operation of determining the second unique device identifier of the second network device comprises at least one of examining a release packet from the second network device, and accessing a table containing unique device identifiers referenced by assigned network addresses.

20. An apparatus comprising:
a set of one or more processing units;
a network interface; and
an automatic network configuration unit operable to,
detect connection of a first network device to a network;
determine a first unique device identifier of the first network device;
determine that the first unique device identifier is associated with a first network services profile, wherein the first network services profile indicates network services to configure for the first network device;
retrieve the first network services profile from a profile database;
configure network services indicated in the first network services profile; and
assign a first network address to the first network device.
